(19) United States
(12) Patent Application Publication
(10) Pub. No.: US 2020/0216646 A1
(43) Pub. Date: Jul. 9, 2020

(54) BLOCK COPOLYMERIC ANTISTATIC AGENT COMPRISING HYDROPHILIC BLOCKS AND HYDROPHOBIC BLOCKS, ANTISTATIC POLYOLEFIN FILM COMPRISING THE SAME AND PREPARATION METHOD THEREOF

(71) Applicant: AICELLO MILIM CHEMICAL CO., LTD., Siheung-si (KR)

(72) Inventor: Jung Hwan LIM, Yongin-si (KR)

(21) Appl. No.: 16/244,009

(22) Filed: Jan. 9, 2019

(51) Int. Cl. C08L 23/06; C08G 81/02; C08J 3/20; C08J 5/18

(52) U.S. Cl. CPC C08L 23/06; C08G 81/025; C08J 3/203; C08L 2201/04; C08J 2323/06; C08J 2487/00; C08L 2203/16; C08J 5/18

(57) ABSTRACT

An antistatic agent for polyolefin and an antistatic polyethylene film including the same, wherein the antistatic agent is configured to include a hydrophilic block and a hydrophobic block which are connected by an ether or an ester bond in a weight ratio of 1:0.1˜100, and formed of a block copolymer having a weight-average molecular weight of 10 to 100 kDa is provided.

The antistatic polyethylene film including a block copolymer antistatic agent according to the present disclosure allows minimized bleed outs or mobility, so the cleanliness (degree of cleanness) is very high, and has a desired antistatic effect even without the use of additional additives, and it has similar physical properties and workability to that of the base resin, polyolefin.

### BACKGROUND OF THE INVENTION

### 1. Field of the invention

The present disclosure relates to a block copolymer antistatic agent for polyolefin including one or more hydrophilic blocks and one or more hydrophobic blocks, and an antistatic polyolefin film including the same. In particular, the present disclosure relates to a block copolymer antistatic agent for polyolefin which is configured of a block copolymer in which a poly(alkylene oxide) block having a hydroxyl group at both terminals and a polyalkylene block functionalized at both terminals are connected through an ether or an ester bond, and an antistatic polyolefin film including the same.

### 2. Description of the Related Art

Electrical and electronic equipment uses electrical components and/or electronic components (hereinafter referred to as “electrical and electronic components”) such as silicon wafers, hard disks, magnetic disk substrates, glass substrates, IC chips, semiconductors, optical storage disks, color filters, hard disk magnetic head element, charge coupled element (CCD element) and the like. To assemble these electric and electronic devices, it is necessary to transport and transfer the components in order to supply the components to the assembly line, and thereby containers for transferring are used. Further, when the components are accommodated and stored as an intermediate product or product, a storage container or a packaging material can be used.

Conventionally, as a container for transporting electrical and electronic components, a container for storage and a packaging material for packaging electrical and electronic components, a synthetic resin such as a polyolefin-based resin or polystyrene-based resin which is excellent in formability or chemical resistance, is being used.

However, since polyethylene has an antistatic coefficient (surface resistance) of 10¹⁶Ω or more in material properties, it is liable to generate static electricity, which is a cause of malfunction, or attracts dust or the like, which may cause a big problem.

Therefore, in order to prevent static electricity, a low molecular type antistatic agent or a polymer type antistatic agent is added to the synthetic resin, which is prepared in the form of an antistatic film with an antistatic coefficient (surface resistance) in a level of 10¹⁰ to 10¹²Ω. The low-molecular antistatic agent is eluted by bleeding out, so all the objects that come into contact can be contaminated, so its use is limited when it comes to packaging material for electrical and electronic parts that emphasizes prevention of contamination.

Recently, a plurality of polymer type antistatic agents has been proposed which do not bleed out and do not contaminate upon contact (for example, Patent Documents 1 to 3). However, since these polymer type antistatic agents must have appropriate compatibility and dispersibility with the base resin, it is necessary to develop a new polymer type antistatic agent depending on the type of the base resin. Further, in many cases, the agents contain an electrolyte such as an alkali metal for the purpose of improving the antistatic property. When used in a storage and transportation container for an electric and electronic component, ions eluted from the molded article become a problem. On the other hand, in the case where the electrolyte is not contained, although the elution of ions is small, there is a problem that sufficient antistatic performance cannot be obtained. Therefore, the current state of the art requires a resin composition which is durable and has sufficient antistatic property while having a small amount of, or no elution of ions.

In this case, in order to impart antistatic properties to a polyethylene film for electric and electronic components, it is required to develop a new polymer antistatic agent and an antistatic polyethylene film packaging material containing the same, that impart excellent antistatic effects even without the use of additives such as alkali metal salts, have excellent compatibility or dispersibility, and do not contaminate the packaged articles by minimizing dissolution or mobility.

As prior arts, there is Japanese Laid-Open Patent Publication No. 2012-62067 (Patent Document 1), Japanese Laid-Open Patent Publication No. Hei 8-12755 (Patent Document 2) and Japanese Laid-Open Patent Publication No. 2001-278985 (Patent Document 3).

### SUMMARY OF THE INVENTION

The present inventors have made efforts to develop a novel copolymer antistatic agent and an antistatic polyethylene film including the same, is excellent in compatibility or dispersibility with polyethylene as a substrate polymer to minimize bleeding or mobility, and even without the use of additional additives, can have the desired antistatic effect.

The inventors of the present disclosure have intensively studied in order to solve the technical problems as described above, and as a result, by kneading an antistatic polymer compound having a specific structure with polyethylene and extruding in a film form, a method capable of solving the above technical problems was found and so the present invention was completed.

In other words, the present inventors have found that when an antistatic agent formed of a block copolymer including a hydrophilic block and a hydrophobic block has the following structural features, the compatibility or dispersibility with polyolefin as base resin is excellent, which minimizes bleed outs or mobility, so the cleanliness (degree of cleanness) is very high, and the desired antistatic effect can be imparted to the base resin, polyolefin, even without the use of additional additives. Also, it was found that such structural features do not inhibit the physical properties and workability of the base resin, polyolefin, and so the present invention was completed:

(a) as a hydrophilic block which is important for antistatic property, a polyalkylene oxide block having a hydroxyl group at both terminals is used, and as a hydrophobic block which is important for compatibility and dispersibility with the polyolefin, a polyolefin block which is functionalized at both terminals is used, and

(b) the above-mentioned hydrophilic block and the hydrophobic block are connected through an ether bond or an ester bond, and more specifically, the above-mentioned hydrophilic polyalkylene oxide block and the above-mentioned hydrophobic polyolefin block are connected by an ester bond, and the above-mentioned ester bond is formed by a reaction of a polyolefin block functionalized by dicarboxylic acid or an anhydride thereof at both terminals with a polyalkylene oxide having hydroxyl at both terminals, and

(c) the above-mentioned hydrophilic block and the hydrophobic block is included in the antistatic agent in a weight ratio of 1:0.1˜100, and

(d) a block copolymer including the hydrophilic block and the hydrophobic block has a weight-average molecular weight of 10 to 100 kDa.

An antistatic polyethylene film including a block copolymer antistatic agent according to the present disclosure allows minimized bleed outs or mobility, so the cleanliness (degree of cleanness) is very high, and has a desired antistatic effect even without the use of additional additives. Also, it has similar physical properties and workability to that of the base resin, polyolefin, and thus can be usefully utilized in the semiconductor industry, pharmaceutical industry, food industry, and so on, which require both of an excellent antistatic effect and a high degree of cleanliness.

### DETAILED DESCRIPTION OF THE INVENTION

The present disclosure is directed to provide a block copolymer antistatic agent for polyolefin including one or more hydrophilic blocks and one or more hydrophobic blocks, having the following structural features:

(a) as a hydrophilic block which is important for antistatic property, a polyalkylene oxide block having a hydroxyl group at both terminals is used, and as a hydrophobic block which is important for compatibility and dispersibility with the polyolefin, a polyolefin block which is functionalized at both terminals is used, and

(b) the above-mentioned hydrophilic block and the hydrophobic block are connected through an ether bond or an ester bond,

(c) the above-mentioned hydrophilic block and the hydrophobic block are included in the antistatic agent in a weight ratio of 1:0.1˜100, and

(d) a block copolymer including the hydrophilic block and the hydrophobic block has a weight-average molecular weight of 10 to 100 kDa.

The present disclosure is also directed to provide a preparation method of an antistatic polyethylene film including the flowing steps:

(1) preparing one or more terminally-functionalized poly(ethylene-propylene) copolymer blocks and one or more polyethylene oxide blocks to have a weight ratio of 1:0.1˜10, preferably included in a weight ratio of 1:0.5˜5, and a block copolymer having a weight-average molecular weight of 10 to 100 kDa, preferably from 20 to 80 kDa, as an antistatic agent,

(2) mixing the antistatic agent block copolymer prepared in the above step (1) with a polyolefin in an amount of 0.01 to 50% by weight,

(3) melt-extruding the mixture obtained in the above step (2) into a film form by way of casting or blowing at a temperature of 100° C. to 300° C., and

(4) optionally, the cast film or blown film obtained in the above step (3) is laminated or laminated with another film.

The present disclosure is also directed to provide an antistatic polyolefin film which includes the above-mentioned antistatic agent or is prepared by the above-mentioned method. The antistatic polyolefin film which has an antistatic coefficient of 10⁹ to 10¹²Ω in a state maintaining a cleanliness of preferably 1,000 or less particles, and more preferably 100 or less particles of 0.1 μm or more per unit area, when measured by a liquid particle counter, may be provided.

Hereinafter, an antistatic block copolymer, an antistatic polyethylene film including the same, and a preparation thereof according to the present disclosure will be described in detail.

A. Base Resin

In the present disclosure, a base resin for containing an antistatic agent or a base resin for imparting antistatic properties is a polyethylene resin widely used as a packaging material for electric and electronic products. For example, low density polyethylene, linear low density polyethylene and high density polyethylene can be exemplified.

According to one method of the present disclosure, another polyolefin-based resin may be used in place of or in combination with polyethylene. Examples of such polyolefin-based resin include, for example, an α-olefin polymer such as, low-density polyethylene, linear low-density polyethylene, high-density polyethylene, homopolypropylene, random copolymer polypropylene, block copolymer polypropylene, isotactic polypropylene, syndiotactic polypropylene, hemi-isotactic polypropylene, polybutene, cycloolefin polymer, stereoblock polypropylene, polyethylene-3-methyl-1-butene, poly-3-methyl-1-pentene, poly-4-methyl-1-pentene and so on, and an α-olefin copolymer such as, ethylene-propylene block or random copolymer, impact copolymer polypropylene, ethylene-methyl methacrylate copolymer, ethylene methyl acrylate copolymer, ethylene ethyl acrylate copolymer, ethylene butyl acrylate copolymer, ethylene vinyl acetate copolymer and so on, and a polyolefin-based thermoplastic elastomer may be included, and two or more kinds of copolymers of such may be included. These polyolefin-based resins may also be used in two or more types.

Depending on the case, a polystyrene-based resin may be further included. For example, a vinyl group-containing aromatic hydrocarbon can be included alone or can be included as a copolymer together with other monomers (for example, maleic anhydride, phenylmaleimide, (meth) acrylate, butadiene, (meth) acrylonitrile and so on). Also, for example, a thermoplastic resin such as polystyrene (PS) resin, high impact polystyrene (HIPS), acrylonitrile-styrene (AS) resin, acrylonitrile-butadiene-styrene (ABS) resin, methacrylate-butadiene-styrene (MBS) resin, heat-resistant ABS resin, acrylonitrile-acrylate-styrene (AAS) resin, styrene-maleic anhydride alkyd (SMA) resin, methacrylate-styrene (MS) resin, styrene-isoprene-styrene (SIS) resin, acrylonitrile-ethylene propylene rubber-styrene (AES) resin, styrene-butadiene-butylene-styrene (SBBS) resin, methyl methacrylate-acrylonitrile-butadiene-styrene (MABS) resin can be included. Also, for example, a hydrogenated styrene-based elastomer resin in which the double bond of these butadiene or isoprene is hydrogenated, such as styrene-ethylene-butylene-styrene (SEBS) resin, styrene-ethylene-propylene-styrene (SEPS) resin, styrene-ethylene-propylene (SEP) resin, styrene-ethylene-ethylene-propylene-styrene (SEEPS) resin and so on can be included. One or more of the above-mentioned exemplary resins may be used.

In a base resin of the present disclosure, as a synthetic resin other than a polyolefin resin and polystyrene-based resin, for example, a halogen-containing resin such as polyvinyl chloride, polyvinylidene chloride, chlorinated polyethylene, chlorinated polypropylene, polyvinylidene fluoride, chlorinated rubber, vinyl chloride-vinyl acetate copolymer, vinyl chloride-ethylene copolymer, vinyl chloride-vinylidene chloride copolymer, vinyl chloride-vinylidene chloride-acetic acid vinyl terpolymer, vinyl chloride-acrylate ester copolymer, vinyl chloride-maleic acid ester copolymer, vinyl chloride-cyclohexylmaleimide copolymer; petroleum resin, coumarone resin, polyvinyl acetate, acrylic resin, polymethyl methacrylate, polyvinyl alcohol, polyvinyl formal, polyvinyl butyral; polyalkylene terephthalate such as polyethylene terephthalate, polybutylene terephthalate, polycyclohexanedimethylene terephthalate and so on, aromatic polyesters such as polyalkylene naphthalate such as polyethylene naphthalate, polybutylene naphthalate and so on, and linear polyester such as polytetramethylene terephthalate and so on; degradable aliphatic polyesters such as polyhydroxybutyrate, polycaprolactone, polybutylene succinate, polyethylene succinate, polylactic acid, polymaleic acid, polyglycolic acid, polydioxane, and poly (2-oxetanone) and so on; polyamide such as polyphenylene oxide, polycaprolactam and polyhexamethylene adipamide and so on, and thermoplastic resin, such as polycarbonate, polycarbonate/ABS resin, branched polycarbonate, polyacetal, polyphenylene sulfide, polyurethane, cellulose-based resin, polyimide resin, polysulfone, polyphenylene ether, polyether ketone, polyether ether ketone, liquid crystal polymer and so on, and a mixture of these can be used. Further, isoprene rubber, butadiene rubber, acrylonitrile-butadiene copolymer rubber, styrene-butadiene copolymer rubber, fluororubber, silicone rubber, polyester-based elastomer, nitrile-based elastomer, nylon-based elastomer, vinyl chloride-based elastomer, polyamide-based elastomer, polyurethane-based elastomer and such elastomers can be used.

In a base resin of the present invention, these synthetic resins may be used alone or in combination of two or more kinds. Also, it can be alloyed. On the other hand, these synthetic resins may be used regardless of their molecular weight, degree of polymerization, density, softening point, ratio of insoluble matter to solvent, degree of stereo-regularity, presence or absence of catalyst residue, type or mixing ratio of monomer as a raw material, and type of polymerization catalyst (for example, a Ziegler catalyst, a metallocene catalyst, and so on).

B. Polymeric Antistatic Agent

The antistatic copolymer that may be used in the present disclosure has the following structural features:

(a) the above-mentioned hydrophilic portion which is important for antistatic property is selected from a polyalkylene oxide block, and as the above-mentioned hydrophobic portion which is important for compatibility and dispersibility with the base polymer, polyalkylene copolymer is used, and

(b) the above-mentioned hydrophilic block and the hydrophobic block are connected through an ether bond or an ester bond, and more preferably the above-mentioned ether bond or ester bond is derived from an epoxy group or a dicarboxylic anhydride, having a free alcohol value or an acid value of 0.1 to 1 eq/g, preferably from 0.2 to 0.8 eq/g, and more preferably from 0.2 to 0.5 eq/g, and

(c) the above-mentioned hydrophilic block and the hydrophobic block are included in the antistatic agent in a weight ratio of 1:0.1˜100, and

(d) the above-mentioned copolymer has a weight-average molecular weight of 10 to 100 kDa.

According to a preferred embodiment of the present disclosure, the above antistatic copolymer,

(a1) includes one or more terminally-functionalized poly(ethylene-propylene) copolymer blocks and one or more polyethylene oxide blocks in a weight ratio of 1:0.1˜10, preferably in a weight ratio of 1:0.5˜5, and has a weight-average molecular weight of 10 to 100 kDa, and preferably from 20 to 80 kDa, and

(b1) is derived from a terminal epoxy group or dicarboxylic anhydride of the above-mentioned terminally functionalized poly(ethylene-propylene) copolymer block, and reacts with the above-mentioned polyethylene oxide block to form an ether bond or an ester bond.

In the present disclosure, the terminal functional group of the poly(ethylene-propylene) copolymer block refers to a group capable of reacting with a terminal hydroxyl group of the polyethylene oxide block, and examples thereof include a carboxylic acid group, an ester or an anhydride thereof, and epoxy groups and so on, and preferably, a dicarboxylic anhydride epoxy group can be mentioned.

According to a more preferred embodiment of the present disclosure, in the above-mentioned antistatic copolymer, a free alcohol group-containing ether binding site or a free carboxylate group-containing ester binding site formed by a reaction of a poly(ethylene-propylene) copolymer block terminally functionalized by an epoxy group or a dicarboxylic anhydride with the above-mentioned polyethylene oxide block is included.

According to a preferred embodiment of the present disclosure, the above-mentioned terminally functionalized poly(ethylene-propylene) copolymer block can be obtained by functionalizing the terminals as an epoxy group-containing compound, an α,β-unsaturated carboxylic acid or an anhydride thereof.

According to a preferred embodiment of the present disclosure, the above-mentioned terminally functionalized poly(ethylene-propylene) copolymer block may have a repeating unit ratio of ethylene : propylene of 1:10˜50, preferably 1:20˜40. The repeating unit is 30 to 100, preferably 40 to 80, and the polyethylene oxide block may have an ethylene oxide repeating unit of 20 to 150, and more preferably a repeating unit of 40 to 100.

According to a preferred embodiment of the present disclosure, in the above-mentioned antistatic block copolymer, the above-mentioned free alcohol or free carboxylic acid group may be protected or blocked, for example, by an amino group-containing fatty acid by esterification, amidation or imidization.

According to a preferred embodiment of the present disclosure, the above-mentioned polyethylene film might not further contain an electrolyte such as a salt, a surfactant, or the like as an additive for further enhancing an antistatic effect or for kneading or processing an antistatic agent.

According to one method of the present disclosure, the above-mentioned antistatic block copolymer may have a structure wherein, a poly(ethylene-propylene) copolymer block having an epoxy ring or an acid anhydride ring at its terminal and a polyethylene oxide block are connected by an ether bond or an ester bond formed by a ring opening reaction of the above-mentioned epoxy ring or the anhydride ring. Thus, a free alcohol group or a free carboxylic acid group may remain in the above-mentioned ether or ester binding site.

According to a preferred embodiment of the present disclosure, in the above-mentioned free alcohol group or free carboxylic acid group, a functional group capable of reacting with an alcohol group or a carboxylic acid group to form another ether bond, ester bond, amino bond, amide bond, imide bond and so on to adhere a pendant compound or a pendant block having at least two functional groups may be included. Thus, it is possible to further prevent bleed outs and mobility, and the antistatic effect can be further improved.

The above-mentioned pendant compound or pendant block having at least two functional groups may be, for example, a diol having a carbon number of 6 to 20, a dicarboxylic acid, a diamine, an amino alcohol, an amino fatty acid, a hydroxy fatty acid and so on. Preferably, a pendant compound or block having two functional groups at both terminals of a hydrocarbon group having 6 to 20 carbon atoms, and examples thereof include α,ω-diol, α,ω-dicarboxylic acid, α,ω-di amine, α,ω-amino alcohol, ω-hydroxy fatty acid, ω-amino fatty acid, and so on.

For example, α,ω-diol (e.g., 1,6-hexanediol, 2-methyl-1,8-octanediol, 1,9-nonanediol, 1,10-decanediol, 1,12-dodecanediol, 1,13-tridecanediol, 1,14-tetradecanediol, 1,16-hexadecanediol, 1,18-octadecanediol, an ethylene oxide adduct of bisphenol A, a propylene oxide adduct of bisphenol A, a poly hydroxyethyl adduct of a mononuclear divalent phenol compound), and an aliphatic dicarboxylic acid having 2 to 20 carbon atoms (for example, oxalic acid, malonic acid, succinic acid, glutaric acid, methyl succinic acid, dimethylmalonic acid, β-methylglutaric acid, ethyl succinic acid, isopropylmalonic acid, adipic acid, pimelic acid, suberic acid, azelaic acid, sebacic acid, undecandioic acid, dodecanedioic acid, tridecanedioic acid, tetradecanedioic acid, hexadecandioic acid, octadecanedioic acid and eicosanedioic acid and so on), α,ω-diamine (for example, N,N′-dimethyl hexamethylene diamine, N,N′-diethyl hexamethylene diamine, N,N′-dibutyl hexamethylene diamine, N,N′-dimethyl decethylene diamine, N,N′-diethyl decamethylene diamine and N,N′-dibutyl decamethylene diamine and so on), ω-ammonia fatty acid (e.g., 6-aminohexanoic acid, 7-aminoheptanoic acid, 8-aminooctanoic acid, 9-aminononanoic acid, 10-aminocapric acid, 12-aminolauric acid, 14-aminomeric acid, 18-amino oleic acid, and so on), or ω-hydroxy fatty acid (e.g., 6-hydroxy hexanoic acid, 7-hydroxyheptanoic acid, 8-hydroxyoctanoic acid, 9-hydroxynonanoic acid, 10-hydroxycapric acid, 12-hydroxylauric acid, 14-hydroxymyric acid, 18-hydroxyoleic acid, and so on).

In the present disclosure, as the polyalkylene oxide block, polyethylene glycol represented by the following Chemical formula 1 is preferable.

[Chemical formula 1]

HO—(CH₂—CH₂—O)ₘ—H)

In the above formula, m represents a number of 5 to 250. In terms of heat resistance or compatibility, m is preferably from 20 to 150.

As the polyalkylene oxide block, in addition to the polyethylene glycol obtained by the addition reaction of ethylene oxide, there can be a polyester formed by adding and reacting one or more types of ethylene oxide and other alkylene oxides (for example, propylene oxide, 1,2-butylene oxide, 1,4-butylene oxide, 2,3-butylene oxide or 1,3-butylene oxide and so on). It is possible for the polyester to be random, but it can also be a block.

Further, examples of the polyalkylene oxide block include a compound having a structure in which an ethylene oxide is added to an active hydrogen atom containing-compound or a compound having a structure in which one or more types of ethylene oxide and another alkylene oxide (for example, propylene oxide, 1,2 butylene oxide, 1,4-butylene oxide, 2,3-butylene oxide or 1,3-butylene oxide and the like) are added. These may be any of random addition and block addition.

Examples of the active hydrogen atom-containing compound can include glycol, divalent phenol, primary monoamine, secondary diamine, dicarboxylic acid and so on.

As the glycol, aliphatic glycols having 2 to 20 carbon atoms, alicyclic glycols having 5 to 12 carbon atoms, aromatic glycols having 8 to 26 carbon atoms, and the like can be used.

As examples of the aliphatic glycol, there can be ethylene glycol, 1,2-propylene glycol, 1,3-propanediol, 1,2-butanediol, 1,3-butanediol, and 1,4-butanediol, 1,3-hexanediol, 1,4-hexanediol, 1,6-hexanediol, 2,5-hexanediol, 1,2-octanediol, 1,8-octanediol, 1,10-decanediol, 1,18-octadecanediol, 1,20-eicosanediol, diethylene glycol, triethylene glycol, thiodiethylene glycol and so on.

As examples of the alicyclic glycol, there can be 1-hydroxymethyl-1-cyclobutanol, 1,2-cyclohexanediol, 1,3-cyclohexanediol, 1,4-cyclohexanediol, 1-methyl-3,4-cyclohexanediol, 2-hydroxymethylcyclohexanol, 4-hydroxymethylcyclohexanol, 1,4-cyclohexanedimethanol, and 1,1′-dihydroxyl-1,1′-dicyclohexanol and the like.

As examples of the aromatic glycol, there can be, dihydroxymethylbenzene, 1,4-bis(β-hydroxyethoxy)benzene, 2-phenyl-1,3-propanediol, 2-phenyl-1,4-butanediol, 2-benzyl-1,3-propanediol, triphenylethylene glycol, tetraphenyl ethylene glycol, benzopinacol, and the like.

As the divalent phenol, a phenol having 6 to 30 carbon atoms can be used, for example, catechol, resorcin, 1,4-dihydroxybenzene, hydroquinone, bisphenol A, bisphenol F, bisphenol S, dihydroxydiphenyl ether, dihydroxyphenylthioether, binaphthol and alkyl groups thereof (having 1 to 10 carbon atoms) or halogen substituents.

In a preferred embodiment of the present disclosure, the antistatic block copolymer preferably has a structure in which the above-mentioned hydrophilic block and hydrophobic block is connected through a binding site of ether or ester having a free alcohol group or a free carboxylic acid group, in terms of improving antistatic property, preventing bleeding, and suppressing mobility.

In a preferred embodiment of the present disclosure, the above-mentioned antistatic block copolymer is preferably configured by repeated interlocking of the above-mentioned hydrophilic block and hydrophobic block, connected through a binding site of ether or ester having a free alcohol group or a free carboxylic acid group, in terms of improving antistatic property, preventing bleeding, and suppressing mobility. More preferably, in the antistatic block copolymer, both terminals have terminals derived from an epoxy ring or a dianhydride ring and preferably these are blocked or protected by a pendant compound or block having at least two functional groups.

In the present disclosure, the polyalkylene oxide block has a hydroxyl group at both terminals, and both terminals are reacted with an epoxy group or a dianhydride ring of a poly(ethylene-propylene) block copolymer functionalized with an epoxy group or a dianhydride to form an ether bond or an ester bond while forming a free alcohol group or a free carboxyl group at the linking site, which can react with the pendant compound or block to allow the introduction of a pendant.

In a preferred embodiment of the present disclosure, the poly(ethylene-propylene) copolymer block (A) functionalized at both terminals by a dicarboxylic acid group or an anhydride thereof, and the polyethylene oxide block (B) having a hydroxyl group at both terminals react and through an ester bond it can be interlocked repeatedly to be produced in a block copolymer structure. For example, a block copolymer (C) represented by the following Chemical formula 2 can be prepared.

[Chemical formula 2]

HO₂C-(A)-CO-[-0-(B)-O₂C-(A)-CO—]ₜ—OH

In the above formula, (A) represents a hydrophobic poly(ethylene-propylene) copolymer block (A) in which both terminals are functionalized with a dicarboxylic acid group or an anhydride thereof, and (B) represents a hydrophilic polyethylene oxide block (B) having a hydroxyl group at both of the terminals. Here, t represents the number of repetitions of the repeating unit, and preferably represents the number of 1 to 10. More preferably, t is a number from 1 to 7, most preferably a number from 1 to 5.

In a block copolymer (C) including one or more of the above-mentioned hydrophobic blocks and one or more hydrophilic blocks, a part of the block composed of the hydrophobic block (A) may be partially substituted by another polyalkylene block.

The hydrophobic poly(ethylene-propylene) copolymer block (A) functionalized by a dicarboxylic acid group or an anhydride thereof at both terminals can be obtained by adding a precursor of the above-mentioned dicarboxylic acid group or an anhydride thereof during polymerization of ethylene and propylene. However, as shown by the block copolymer (C) represented by Chemical formula 2, if one or more hydrophilic blocks (A) and one or more hydrophobic blocks (B) have a structure equivalent to a structure configured by repeated interlocking through an ester bond formed by the hydroxyl group and the hydroxyl group, it is not necessary to synthesize the hydrophobic block (A) and the hydrophilic block (B).

When the reaction ratio of the hydrophobic block (A) to the hydrophilic block (B) is adjusted to be X+1 moles with respect to X mole of the hydrophilic block (B), it is possible to obtain a block copolymer (C) in which both terminals are functionalized with a dicarboxylic acid group or an anhydride thereof.

In the reaction, after the completion of the synthesis reaction of the hydrophobic block (A), the reaction can be performed by adding the hydrophilic block (B) to the reaction system without directly separating the hydrophobic block (A).

According to a preferred embodiment of the present disclosure, in the block copolymer (C) of the Chemical formula 2, the dicarboxylic acid group or its anhydride present at both terminals can have an imidized structure by reacting a pendant compound or pendant block having at least two functional groups, and preferably, reacting a pendant compound or block wherein one of the functional groups is an amine. That is, in the case where the pendant compound having a reactive functional group is a polyvalent epoxy compound having two or more epoxy groups, an ester bond is formed by the carboxyl group at the terminal of the block copolymer (C) and the epoxy group of the polyvalent epoxy compound. In the case where the pendant group compound having a reactive functional group is a polyhydric alcohol compound having three or more hydroxyl groups, an ester bond is formed by the carboxyl group at the terminal of the block copolymer (C) and the hydroxyl group of the polyhydric alcohol compound. In the case where the pendant compound having a reactive functional group is a polyamine compound having two or more amino groups, an imide bond is formed by the dicarboxylic acid group at the terminal of the block copolymer (C) and the amino group of the polyamine compound.

Further, the block copolymer (C) of the above Chemical formula 2 may further contain an ester bond, an amide bond, or an imide bond formed by a dicarboxylic acid group of both functionalized terminals of the hydrophobic block (A) or a reactor of a pendant compound having a diol group and the reactive functional group. That is, in the case where the pendant group compound having a reactive functional group is a polyvalent epoxy compound, an ester bond formed by the diol group of both terminals of the hydrophobic block (A) and the epoxy group of the polyvalent epoxy compound (D1) may be included. In the case where the pendant group compound having a reactive functional group is a polyhydric alcohol compound, the ether bond formed by a carboxyl group of the hydrophobic block (A) and a hydroxyl group of the polyhydric alcohol compound may be included. In the case where the pendant compound having a reactive functional group is a polyamine compound, an imide bond formed by the dicarboxylic acid group of the hydrophobic block (A) and the amino group of the polyamine compound may be included.

In the case where the both terminals of the block copolymer (C) are dicarboxylic acids or anhydrides thereof, the antistatic block copolymer according to the present disclosure can be prepared by reacting with a pendant compound having an amine group as a reactive functional group. Preferably, the number of amino groups of the pendant compound amino group having an amine group as the reactive functional group may be 0.5 to 5 equivalents, more preferably 0.5 to 1.5, based on the number of the dicarboxylic acid group of the block copolymer (C) to be reacted or its anhydride. Further, the above reaction can be carried out in various solvents, and can also be carried out in a molten state.

In the case where the both terminals of the block copolymer (C) are a diol group, the antistatic block copolymer according to the present disclosure can be prepared by reacting with a pendant compound having a carboxyl group as a reactive functional group. Preferably, the number of carboxyl groups of the pendant compound having a carboxyl group as the reactive functional group may be 0.5 to 5 equivalents, more preferably 0.5 to 1.5 equivalents, based on the number of the diol groups of the block polymer (C) to be reacted. Further, the above reaction can be carried out in various solvents, and can be carried out in a molten state.

In the case where the both terminals of the block copolymer (C) are an epoxy group, the antistatic block copolymer according to the present disclosure can be prepared by reacting with a pendant compound having a hydroxyl group or an amino group as a reactive functional group. Preferably, the number of the hydroxyl group or the amino group as the reactive functional group may be 0.5 to equivalents, more preferably 0.5 to 1.5 equivalents, based on the number of epoxy groups of the block copolymer (C) to be reacted. Further, the above reaction can be carried out in various solvents, and can also be carried out in a molten state.

In the antistatic block copolymer according to the present disclosure, it is preferable that the number average molecular weight of the poly(ethylene-propylene) copolymer block as the hydrophobic block is 800 to 8,000 in terms of polystyrene, and more preferably from 1,000 to 6,000, and particularly preferably from 2,000 to 4,000. Further, the number average molecular weight of the poly(alkylene oxide) block (B) as the hydrophilic block is preferably from 400 to 6,000, more preferably from 1,000 to 5,000, particularly preferably from 2,000 to 6,000 in terms of polystyrene.

In the antistatic block copolymer of the present disclosure, the number average molecular weight of the block copolymer (C) represented by the Chemical formula 2 is preferably 5,000 to 25,000, more preferably 7,000 to 17,000 in terms of polystyrene, and particularly preferably 9,000 to 13,000.

The compounding amount of the antistatic block copolymer according to the present disclosure is 0.01 to 50% by weight, preferably 5 to 40% by weight, and particularly preferably 10 to 40% by weight in terms of antistatic property and ion dissolution inhibition. When the compounding amount is less than 0.01% by weight, sufficient antistatic properties are not obtained, and when it is more than 50% by weight, the physical properties and workability of the base resin may be lowered.

Further, a known polymer type antistatic agent may be added to the antistatic polyethylene film of the present invention as needed.

As a polymer type antistatic agent which can be added to the present invention, for example, a polymer type antistatic agent such as a known polyether ester amide can be used, and a known polyether ester amide can be used, for example, a polyether ester amide formed from a polyoxyalkylene adduct of bisphenol A disclosed in Japanese Laid-Open Patent Publication No. Hei 7-10989. Further, a block polymer having a repeating structure of 2 to 50 in which the bonding unit of the polyolefin block and the hydrophilic polymer block can be used, and a block polymer described in the specification of U.S. Pat. No. 6,552,131 can be taken as an example.

The compounding amount in the case of blending the polymer type antistatic agent with respect to 100 parts by mass of the synthetic resin is preferably 0.1 to 10% by weight, and more preferably 0.5 to 5% by weight.

Further, the antistatic polyethylene film of the present d may contain a compatibilizing agent without departing from the effects of the present invention. The compatibility of the antistatic component with other components or resin components can be improved by blending a compatibilizing agent.

The compatibilizing agent may, for example, be a modified vinyl polymer having at least one functional group (polar group) selected from the group consisting of a carboxyl group, an epoxy group, an amino group, a hydroxyl group, and a polyoxyalkylene group. For example, there is a polymer described in Japanese Laid-Open Patent Publication No. Hei3-258850, a modified vinyl polymer having a sulfonyl group described in Japanese Laid-Open Patent Publication No. Hei 6-345927, a block polymer having a polyolefin portion and an aromatic vinyl polymer portion, or the like.

Preferably, the compounding amount in the case of dissolving the compatibilizing agent is 0.01 to 5 parts by mass, more preferably 0.1 to 3 parts by mass, per 100 parts by mass of synthetic resin.

Further, a phenolic antioxidant, a phosphorus antioxidant, a thioether-based antioxidant, an ultraviolet absorber, a hindered amine-based light stabilizer and such different kinds of additives may be added to the antistatic polyethylene film of the present disclosure as needed within a range that does not impair the effects of the present invention. By using such additives, it is possible to stabilize the resin composition of the present disclosure.

As examples of the above-mentioned phenolic antioxidant, there can be, 2,6-di-tert-butyl-p-cresol, 2,6-diphenyl-4-octadecyloxyphenol, distearyl(3,5-di-tert-butyl-4-hydroxybenzyl)phosphonate, 1,6-hexamethylenebis[(3,5-di-tert-butyl-4-hydroxyphenyl) propanoic acid amide], 4,4′-thiobis(6-tert-butyl-m-cresol), 2,2′-methylenebis(4-methyl-6-tert-butylphenol), 2,2′-methylenebis (4-ethyl-6-tert-butylphenol), 4,4′-butylene bis(6-tert-butyl-m-cresol), 2,2′-ethylenebis(4,6-di-tert-butylphenol), 2,2′-ethylenebis(4-sec-butyl-6-tert-butylphenol), 1,1,3-tris(2-methyl-4-hydroxy-5-tert-butylphenyl)butane, 1,3,5-tris(2,6-dimethyl-3-hydroxy-4-tert-butylbenzyl)isocyanurate, 1,3,5-tris(3,5-di-tert-butyl 4-hydroxybenzyl)isocyanurate, 1,3,5-tris(3,5-di-tert-butyl-4-hydroxybenzyl)-2,4,6-trimethylbenzene, 2-tert-butyl-4-methyl-6-(2-acryloyloxy-3-tert-butyl-5-methylbenzyl)phenol, stearyl (3,5-di-tert-butyl-4-hydroxyphenyl)propionate, tetrakis[3-(3,5-di-tert-butyl-4-hydroxyphenyl)methyl propanoate]methane, thiodiethylene glycol bis[(3,5-di-tert-butyl-4-hydroxyphenyl)propionate], 1,6-hexamethylene bis[(3,5-di-tert-butyl-4-hydroxyphenyl)propionate], bis[3,3-bis(4-hydroxy-3-tert-butylphenyl)butanoate]ethylene glycol, bis[2-tert-butyl-4-methyl-6-(2-hydroxy-3-tert-butyl-5-methylbenzyl)phenyl]terephthalate, 1,3,5-tri[(3,5-di-tert-butyl-4-hydroxyphenyl)propionyloxyethyl] isocyanurate, 3,9-bis[1,1-dimethyl-2-{(3-tert-butyl-4-hydroxy-5-methylphenyl)propionyloxy}ethyl]-2,4,8,10-tetraoxaspiro[5,5]undecane, triethylene glycol bis[(3-tert-butyl-4-hydroxy-5-methylphenyl)propionate] and the like. Preferably, the phenolic antioxidant is added in an amount of 0.001 to 10 parts by mass, more preferably 0.05 to 5 parts by mass, per 100 parts by mass of the synthetic resin.

As examples of the above-mentioned phosphorus-based antioxidant, there can be, trisnonylphenyl phosphite, tris[2-tert-butyl-4-(3-tert-butyl-4-hydroxy-5-methylphenylthio-5-methylphenyl] phosphite, tridecyl phosphite, octyldiphenylphosphite, di(decyl)monophenyl phosphite, di(tridecyl)pentaerythritol diphosphite, di(nonylphenyl)pentaerythritol diphosphite, bis(2,4-di-tert-butylphenyl)pentaerythritol diphosphite, bis(2,6-di-tert-butyl-4-methylphenyl)pentaerythritol diphosphite, bis(2,4,6-tri-tert-butylphenyl)pentaerythritol diphosphite, bis(2,4-dicumylphenyl)pentaerythritol diphosphorite, tetra(tridecyl)isopropylidenediphenol phosphite, tetra(tridecyl)-4,4′-n-butylenebis(2-tert-butyl-5-methylphenol) diphosphite, hexa(tridecyl)-1,1,3-tris(2-methyl-4-hydroxy-5-tert-butylphenyl)butane triphosphite, tetrakis(2,4-di-tert-butylphenyl)biphenyldiphosphite, 9,10-dihydro-9-oxa-10-phosphaphenanthrene-10-oxide, 2,2′-methylenebis(4,6-tert-butylphenyl)-2-ethylhexylphosphite, 2,2′-methylenebis(4,6-tert-butylphenyl)-octadecylphosphite, 2,2′-ethylenebis(4,6-di-tert-butylphenyl) fluorophosphite, tris(2-[(2,4,8,10-tetra-tert-butyldibenzo [d,f] [1,3,2] dioxaphosphine-6-yl)oxy]ethyl)amine, 2-ethyl-2-butyl propylene glycol, and a phosphite of 2,4,6-tri-tert-butylphenol. Preferably, these phosphorus-based antioxidants may be added in an amount of 0.001 to 10 parts by mass, more preferably 0.05 to 5 parts by mass, per 100 parts by mass of the synthetic resin.

As examples of the above-mentioned thioether-based antioxidant, there can be dialkylthio dipropionate such as thiodipropionate dilauryl, thiodipropionate dimyristyl, thiodipropionate distearyl and so son, and pentaerythritol tetra (β-alkylthiopropionic acid) ester. Preferably, these thioether-based antioxidants may be added in an amount of 0.001 to 10 parts by mass, more preferably 0.05 to 5 parts by mass, per 100 parts by mass of the synthetic resin.

As examples of the above-mentioned ultraviolet absorber, there can be 2-hydroxybenzophenone such as 2,4-dihydroxybenzophenone, 2-hydroxy-4-methoxybenzophenone, 2-hydroxy-4-octoxybenzophenone, 5,5′-methylenebis(2-hydroxy-4-methoxybenzophenone) and so on; 2-(2′-hydroxyphenyl)benzotriazole such as 2-(2′-hydroxy-5′-methylphenyl)benzotriazole, 2-(2′-hydroxy-3′,5′-di-tert-butylphenyl)-5-chlorobenzotriazole, 2-(2′-hydroxy-3′-tert-butyl-5′-methylphenyl)-5-chlorobenzotriazole, 2-(2′-hydroxy-5′-tert-octylphenyl)benzotriazole, 2-(2′-hydroxy-3′,5′-di-cumylphenyl)benzotriazole, 2,2′-methylenebis(4-tert-octyl-6-(benzotriazolyl)phenol, 2-(2′-hydroxy-3′-tert-butyl-5′-carboxyphenyl)benzotriazole and so on; benzoate such as phenyl salicylate, resorcinol monobenzoate, 2,4-di-tert-butylphenyl-3,5-di-tert-butyl-4-hydroxybenzoate, 2,4-di-tert-amylphenyl-3,5-di-tert-butyl-4-hydroxybenzoate, and hexadecyl-3,5-di-tert-butyl-4-hydroxybenzoate; substitute oxanilide such as 2-ethyl-2′-ethoxy oxanilide, 2-ethoxy-4′-dodecyl oxanilide and so on; and cyanoacrylate such as ethyl-α-cyano-β,β-diphenylacrylate, methyl-2-cyano-3-methyl-3-(p-methoxyphenyl)acrylate; and triaryltriazine such as 2-(2-hydroxy-4-octyloxybenzene)-4,6-bis(2,4-di-tert-butylphenyl)-s-triazine, 2-(2-hydroxy-4-methoxyphenyl)-4,6-diphenyl-s-triazine, 2-(2-hydroxy-4-propoxy-5-methylphenyl)-4,6-bis(2,4-di-tert-butylphenyl)-s-triazine. Preferably, these ultraviolet absorbers may be added in an amount of 0.001 to 30 parts by mass, more preferably 0.05 to 10 parts by mass, per 100 parts by mass of the synthetic resin.

As examples of the above-mentioned hindered amine-based light stabilizer, there can be hindered amine compounds such as 2,2,6,6-tetramethyl-4-piperidinyl stearate, 1,2,2,6,6-pentamethyl-4-piperidine stearate, 2,2,6,6-tetramethyl-4-piperidyl benzoate, bis(2,2,6,6-tetramethyl-4-piperidinyl)sebacate, bis(1,2,2,6,6-pentamethyl-4-piperidyl)sebacate, bis(1-octoxy-2,2,6,6-tetramethyl-4-piperidyl)sebacate, tetrakis(2,2,6,6-tetramethyl-4-piperidyl)-1,2,3,4-butane tetracarboxylate, tetrakis(1,2,2,6,6-pentamethyl-4-piperidyl)-1,2,3,4-butane tetracarboxylate, bis(2,2,6,6-tetramethyl-4-(piperidyl).di(tridecyl)-1,2,3,4-butane tetracarboxylate, bis(1,2,2,6,6-pentamethyl-4-piperidyl).di(tridecyl)-1,2,3,4-butane tetracarboxylate, bis(1,2,2,4,4-pentamethyl-4-piperidyl)-2-butyl-2-(3,5-di-tert-butyl-4-hydroxybenzyl)malonate, 1-(2-hydroxyethyl)-2,2,6,6-tetramethyl-4-piperidinol/succinic acid diethyl polycondensate, 1,6-bis (2,2,6,6-tetramethyl-4-piperidinylamino)hexane/2,4-dichloro-6-morpholino-s-triazine polycondensate, 1,6-bis(2,2,6,6-tetramethyl-4-piperidylamino)hexane/2,4-dichloro-6-tert-octylamino-s-triazine polycondensate, 1,5,8,12-tetrakis[2,4-bis(N-butyl-N-(2,2,6,6-tetramethyl-4-piperidyl)amino)-s-triazin-6-yl)]-1,5,8,12-tetrazododecane, 1,5,8,12-tetrakis[2,4-bis(N-butyl-N-(1,2,2,6,6-pentamethyl-4-piperidinyl)amino)-s-triazin-6-yl)]-1,5,8,12-tetrazododecane, 1,6,11-tris[2,4-bis(N-butyl-N-(2,2,6,6-tetramethyl-4-piperidyl)amino)-s-triazin-6-yl)]aminoundecane, 1,6,11-tris[2,4-bis(N-butyl-N-(1,2,2,6,6-pentamethyl-4-piperidyl)amino)-s-triazin-6-yl) aminoundecane and so on. Preferably, these hindered amine-based light stabilizers may be added in an amount of 0.001 to 30 parts by mass, more preferably 0.05 to 10 parts by mass, per 100 parts by mass of the synthetic resin.

Further, it is preferable to further add a known neutralizing agent as needed to neutralize the residual catalyst in a synthetic resin such as a polyolefin-based resin. As examples of the neutralizing agent, there can be fatty acid metal salts such as calcium stearate, lithium stearate, sodium stearate, and so on, or there can be fatty acid amide compounds such as ethylene bis(stearamide), ethylene bis(12-hydroxystearamide), stearic acid amide and so on, and these neutralizing agents can also be used in a combination.

Further, in the antistatic polyethylene film of the present disclosure, an additive which is generally used for a synthetic resin, for example, a crosslinking agent, an antifogging agent, a plate-out inhibitor, a surface treatment agent, a plasticizer, a lubricant, a flame retardant, a fluorescent agent, a fungicide, a bactericide, a foaming agent, a metal deactivator, a releasing agent, a pigment, a processing aid, an antioxidant, a light stabilizer and so on, can be added as needed in a range which does not impair the effect of the present disclosure.

C. Antistatic Polyethylene Film and Preparation Method Thereof

According to the antistatic polyethylene film of the present disclosure, the above-mentioned block copolymer antistatic agent or a master batch including the same is mixed with a polyolefin as a base resin in a content of 0.01 to 50% by weight. The resulting mixture is melt-extruded into a film form by casting or blowing at a temperature of 100° C. to 300° C., and may be prepared by laminating the obtained film or laminating with other films, as the case may be.

Specifically, the preparation method of an antistatic polyethylene film according to the present disclosure may include:

(1) preparing one or more terminally-functionalized poly(ethylene-propylene) copolymer blocks and one or more polyethylene oxide blocks to have a weight ratio of 1:0.1˜10, preferably included in a weight ratio of 1:0.5˜5, and a block copolymer having a weight-average molecular weight of 10 to 100 kDa, preferably from 20 to 80 kDa, as an antistatic agent,

(2) mixing the antistatic agent block copolymer prepared in the above step (1) with a polyolefin in an amount of 0.01 to 50% by weight,

(3) melt-extruding the mixture obtained in the above step (2) into a film form by way of casting or blowing at a temperature of 100° C. to 300° C., and

(4) optionally, the cast film or blown film obtained in the above step (3) is laminated or laminated with another film.

According to an embodiment of the present disclosure, the above-mentioned block copolymer may be prepared as a master batch and used as an antistatic agent, and the master batch may be prepared including 10 to 80% by weight, and preferably 20 to 50% by weight of a block copolymer.

According to an embodiment of the present disclosure, the above-mentioned antistatic block copolymer may be extruded into a film form by casting, for example, by stretching at a stretching ratio of 1 to 10. A film prepared in such a way may be laminated or laminated with another film to prepare a uniaxially stretched film, a biaxially stretched film or a multiaxially stretched film. The above lamination can be performed by a hot melt method or an adhesive method.

According to a preferred embodiment of the present disclosure, the above-mentioned antistatic block copolymer can be prepared into a blown film by a blowing method. Specifically, a material including the above-mentioned antistatic block copolymer is heated in an extruder to be made into a molten state, and the molten material is extruded into a tubular film in a circular mold, and the extruded tubular film is pulled up while air or gas is injected into a tube to form bubbles while cooling the film. In the foaming process in which the above-described bubbles are formed, the foaming ratio (BUR) refers to the ratio of tube expansion, which corresponds to the stretching ratio of the cast film, and can be adjusted by the amount or speed of the injected air or gas. The above-mentioned expansion ratio is not particularly limited and may be selected from 1 to 10 in general, but may be selected from 1 to 5 in particular.

In the present disclosure, as the above-described injecting air or gas, it is preferable to use fresh air or gas in which fine dust or fine particles were removed by filtration.

The film formed in the circular mold can be cooled while being pulled down. However, in this case, there is a problem that it is difficult to increase the bubble ratio or the expansion ratio. It is also possible to horizontally pull out the film formed in the above circular mold.

The above-mentioned blown film may be prepared as a single layer of film (flat plate) by cutting the circular film in half, or may be prepared as two-layer film by compressing two layers of tubular films with a roller or the like. Depending on the case, the above two-layer film may be hot pressed one or two more times to produce a thicker film.

According to one method of the present disclosure, the above antistatic cast or blown film can also be used by laminating or laminating with other films on the outside. The above-mentioned other film may be selected from a film of a polypropylene series having a high elongation, a polyolefin-based film having a low oxygen permeability, or a nylon film excellent in elongation.

The lamination of the above film can be performed by lamination bonding (or dry lamination) or extrusion lamination bonding using an adhesive. The above-mentioned extrusion lamination is carried out by a process of inserting and compressing a molten film between the modified blown film of the present disclosure and another film on the outside after the molten film is prepared. The above-mentioned other polyolefin-based film may be a single layer film or a multilayer film.

According to one method of the present disclosure, a master batch is prepared by kneading the above-mentioned antistatic block copolymer with a base resin. Such a master batch may be mixed with another base resin to prepare a film or molded body. As a method of preparing the master batch, a uniaxial extruder, a biaxial extruder, a multi-axis extruder can be utilized, but in terms of preparation cost and dispersibility, it is desirable to use a biaxial extruder. In particular, by using a master batch, the antistatic agent can be uniformly dispersed when processed into a film or a molded article.

A third aspect of the present disclosure is directed to provide an antistatic polyethylene film prepared by the above-mentioned method.

The antistatic polyolefin film which has an antistatic coefficient of 10⁹ to 10¹²Ω in a state maintaining a cleanliness of preferably 1000 or less particles per unit area (cm²) of particles 0.1 μm or less, preferably 100 or less particles per unit area, when measured by a liquid particle counter, may be provided.

Preferably, an antistatic polyolefin film which has an antistatic coefficient of 10⁹ to 10¹²Ω in a state maintaining a cleanliness of preferably 1,000 or less particles, and more preferably 100 or less particles of 0.1 μm or more per unit area, when measured by a liquid particle counter, may be provided.

The mixing of the antistatic block copolymer of the present disclosure and polyethylene as the base resin may be carried out in a general mixer or a kneader according to methods and conditions well known in the art. For example, it can be mixed, kneaded and combined by a roll kneader, a bumper kneader, an extruder, a kneader and so on.

According to one method of the present disclosure, the above-mentioned antistatic block copolymer can be prepared not only into a film but also in the form of a container or other packaging material. The antistatic block copolymer and polyethylene according to the present disclosure are kneaded and molded in any form, whereby a resin molded body having antistatic properties can be obtained. The molding method is not particularly limited, and examples thereof include extrusion processing, calender finish, injection molding, roll molding, compression molding, blow molding, rotary molding and so on, and various forms of molded articles such as a resin plate, sheet, film, bottle, fibers, shaped products, and so on can be produced. The antistatic molded article prepared according to the present disclosure is excellent in antistatic property and durability.

Further, the molded article prepared from the antistatic block copolymer and the polyethylene according to the present disclosure has almost no bleed outs or dissolution of the antistatic agent and other additives, and so it is possible to achieve a very high level of cleanliness at a state where the antistatic coefficient is maintained at 10⁹ to 10¹²Ω.

For example, by using an antistatic polyethylene film and using a liquid particle counter (LPC) to measure particles of 0.1 μm or more per unit area, the results of evaluation of cleanliness show that antistatic polyethylene films using existing surfactants were measured to have 1,000 particles/cm² or more, but the antistatic polyethylene films prepared according to the present disclosure were measured to have cleanliness levels of 1,000 particles/cm² or less, preferably 500 particles/cm² or less, more preferably 200 particles/cm² or less, and generally it is possible to show a very high level of cleanliness within 100 particles/cm².

According to a preferred embodiment of the present disclosure, the process of preparing the above-mentioned antistatic polyethylene film can be carried out in a clean room used in the semiconductor industry, the pharmaceutical industry, the food industry, and the like.

According to an advantage of the present disclosure, it solved the difficulties (in order to increase the electrification property of the polyethylene film, it was necessary to abandon give up cleanliness and in order maintain cleanliness, it was necessary to give up the electrification property) of coping with a situation in which antistatic properties were needed in the semiconductor industry, the pharmaceutical industry, food industry and so on, where cleanliness in clean rooms play an important role in the quality of the products and so it was confirmed to be useful for industrial use.

A container and a packaging material prepared by using the antistatic block copolymer according to the present disclosure and an antistatic polyethylene including the same are suitable for a storage container, a transfer container, and a packaging material for electric and electronic components. Examples thereof include a silicon wafer, a hard disk, a magnetic disk substrate, a glass substrate, an IC chip, a semiconductor, an optical storage disk, a color filter, a hard disk magnetic head element, a charge coupled device (CCD), and so on, and a transfer container, storage container, tray, case, packaging material for various components or products.

### EXAMPLE

Hereinafter, the present disclosure will be described in further detail by way of examples, but it is not limited thereto. In the following examples and comparative examples, when ┌%┘ and ┌ppb┘ are not particularly described, the weight is used as a basis.

### Preparation Example 1: Preparation of Block Copolymer

### Preparation Example 1: Preparation of an Amide Alcohol Alkylene Oxide Adduct (Ethylene Oxide Adduct)

(Step 1) Preparation of an Amide Alcohol:

3,500 g of ethyl acetate was placed in a glass flask equipped with a nitrogen gas introduction tube, a stirrer, and a thermometer, and the temperature was raised to 40° C. while bubbling nitrogen gas. A mixed solution of 1968 g of monoethanolamine and 528 g of a 28% NaOMe-MeOH solution prepared in advance was added dropwise over 5 hours, and maintained at a temperature of 40° C. under a nitrogen atmosphere for 5 hours. And then using a solvent, unreacted acetic acid and ethanol was removed and 3,415 g of a viscous liquid was obtained. The obtained viscous liquid was analyzed by IR spectral fractionation and the presence of an amide group and an alcohol group was confirmed.

(Step 2) Preparation of an Amide Alcohol Alkylene Oxide Adduct (Ethylene Oxide Adduct):

1060 g of the amide alcohol obtained in the above Step 1 was added and nitrogen substitution was sufficiently performed in the nitrogen introduction tube, stirrer, and stainless steel autoclave (hereinafter, simply referred to as “stainless steel autoclave”). After the temperature was raised to 80° C., 6,000 g of ethylene oxide was added over 5 hours, and the reaction was completed by aging at the same temperature for 2 hours. Subsequently, it was adsorbed and filtered as an adsorbent by adding an appropriate amount of KYOWAAD (authorized trademark) 700 SL (manufactured by Kyowa Chemical Industry Co., Ltd.) to obtain a pale yellow liquid. The hydroxyl value was 80.1 mg KOH/g, and the water content was 0.02%.

### Preparation Example 2: Preparation of a Terminal Acid-Denatured Polypropylene

4,800 parts of low molecular weight polypropylene having 3,300 of Mn and an average terminal double bond number of 0.9 and 200 parts of maleic anhydride were dissolved in a nitrogen gas atmosphere at a temperature of 230° C., and reacted for 12 hours. Subsequently, excess maleic acid was removed under reduced pressure at a temperature of 210° C. for 5 hours to obtain a maleic anhydride denatured product (a terminal acid denatured product) of polypropylene. The Mn was 3,500, the saponification value was 28 mg KOH/g, and the acid denaturation per molecule was 0.92.

### Preparation Example 3: Preparation of Block Copolymer 1

1,000 g of a maleic anhydride denatured product (a terminal acid denatured product) of the polypropylene prepared in the above Preparation Example 2, and 370 g of the amide alcohol ethylene oxide adduct (hydroxyl value 78 mg KOH/g) obtained in Preparation Example 1, 3.2 g of antioxidant (IRGANOX 1010), 24 g of 48% NaOH, and 20 g of ionic water were added to a stainless steel autoclave. Nitrogen substitution was sufficiently carried out, and the temperature was raised to 215° C., followed by stirring for 1 hour. It was kept under a nitrogen atmosphere of 2 kPa or less for 8 hours. The obtained product was a solid polymer (hereinafter referred to as block copolymer 1), and the ester value was 7.4 mg KOH/g. Further, it was confirmed by IR spectrum analysis that the C═O expansion and contraction was 1737 cm⁻¹, and the C(═O)O-reverse symmetric expansion and contraction was 1579 cm⁻¹.

### Preparation Example 4: Preparation of Acid-Denatured Polypropylene at Both Terminals

2,700 parts of a low molecular weight polypropylene having Mn of 8,800 and an average terminal double bond number of 1.65 and 50 parts of maleic anhydride were dissolved in a nitrogen gas atmosphere at a temperature of 220° C., and reacted for 22 hours. Subsequently, excess maleic acid was removed under reduced pressure at a temperature of 200° C. for 4 hours to obtain a maleic anhydride denatured product (two-terminal acid denatured product) of polypropylene. The Mn was 8,800, the saponification value was 19 mg KOH/g, and the degree of acid denaturation per molecule was 1.58.

### Preparation Example 5: Preparation of Block Copolymer 2

1,100 g of a maleic anhydride denatured product (two-terminal denatured product) of the polypropylene prepared in Preparation Example 4, and 55 g of the amide alcohol ethylene oxide adduct (hydroxyl value 78 mg KOH/g) obtained in Preparation Example 1, 4 g of antioxidant (IRGANOX 1010), 15 g of potassium hydroxide, and 10 g of ionized water were added to a stainless steel autoclave. Nitrogen substitution was sufficiently carried out, and the temperature was raised to 220° C., followed by stirring for 1 hour. It was kept at a nitrogen atmosphere of 2 kPa or less again for 8 hours. The obtained product was a solid polymer (hereinafter referred to as block copolymer 1), and the ester value was 6.9 mg KOH/g. Further, it was confirmed by IR spectrum analysis that the C═O expansion and contraction was 1737 cm⁻¹, and the C(═O)O-reverse symmetric expansion and contraction was 1579 cm⁻¹.

### Example 1

100 parts by weight of low density polyethylene (trademark name: LD 830, available in Hanwha Chemical) and parts by weight of the antistatic block copolymer prepared in Preparation Example 5 were mixed in a clean room maintained with a high level of cleanliness. It was supplied to a blow extruder and kneaded at a temperature of about 220° C., and the film was blown using clean air or gas to obtain a film having a thickness of 15 μm.

### Comparative Example 1

A conventional antistatic film was prepared in the same manner as in Example 1 except that 20 parts by weight of a glycerin fatty acid ester-based surfactant (PRETEX-70, available from ILSHINWELLS) was mixed.

### Experimental Example 1

The antistatic polyethylene film prepared in Example 1 and Comparative Example 1 and the polyethylene film (control) not containing any antistatic agents were measured for antistatic property, resin compatibility, transparency and cleanliness according to the following evaluation methods. The results are shown in Table 1.

[Evaluation Method]

(1) Antistatic Property

After being placed in an environment of a temperature of 23° C. and a relative humidity of 50% for one day, the surface resistance of a prepared test piece was measured by using a super insulation meter P-616 manufactured by Kawaguchi Electric Co., Ltd. under the same conditions based on the JIS-K6911 standard. Further, the test piece was immersed in hot water at 80° C. for 30 minutes, and the surface resistance was measured after rubbing the surface with a clean cloth. It was shown that the smaller the value, the better the antistatic property. The target surface resistance (Ω/□) was set to 10¹³ or less. The results obtained are shown in Table 1.

(2) Resin Compatibility (Appearance)

The surface of the polyethylene blown film containing no antistatic agent and the polyethylene blown film including the antistatic agent according to the present disclosure was confirmed by visual comparison. In the case of having the same appearance as the polyethylene blown film containing no antistatic agent which is considered as having excellent compatibility, it was evaluated with a ◯, and in the case where the surface has no streaks, voids or spots but has fog, it was evaluated with a Δ, and in the case where the appearance is poor due to the generation of streaks, voids or spots, it was evaluated with an ×. The results obtained are shown in Table 1.

(3) Transparency

The HAZE value of a produced film and sheet was measured by the HAZE measuring device (HAZEMETER TC-HIIIDPK manufactured by Tokyo Denshoku Co., LTD.), and the difference ΔHAZE between the test piece in which the antistatic agent was not mixed and the test piece in which the above block copolymer was mixed was compared and evaluated. It was shown that the smaller the ΔHAZE, the transparency was closer to the test piece in which the antistatic agent was not mixed. The target of ΔHAZE was 10 or less. The results obtained are shown in Table 1.

(4) Cleanliness

For each test piece, particles of 0.1 μm or more per unit area were measured by using a liquid particle counter and the number of particles was calculated.

TABLE 1

| | | | | | Example 1 |
|---|---|---|---|---|---|
| | | | Control | Comparative | (permanent |
| | | | (clean bag for | example 1 | electrifi- |
| | | | semi- | (general | cation |
| Item | | | conductors) | PE bag) | clean bag) |
| Cleanliness | 0.1 | μm< | 9.8 | NG | 10.7 |
| (ea/cm²) | 0.15 | μm< | 4.1 | 0.1 μm< | 4.1 |
| | 0.2 | μm< | 2.2 | 10,000≤ | 2.3 |
| | 0.3 | μm< | 0.5 | | 0.9 |
| | 0.5 | μm< | 0 | | 0.3 |

| Tensile | MD | 428 | 321 | 543 |
|---|---|---|---|---|
| strength | TD | 473 | 277 | 478 |
| (kgf/cm²) | | | | |
| Elongation | MD | 682 | 1036 | 661 |
| (%) | TD | 630 | 1020 | 688 |
| Elastic | MD | 3213 | 1311 | 2605 |
| modulus | TD | 3365 | 1312 | 2992 |
| (kgf/cm²) | | | | |
| Bonding | | 1.31 | 1.18 | 1.26 |
| strength (kgf/10 mm) | | | | |
| Resin compatibility | | — | Δ | ∘ |
| ΔHaze (%) | | 38 | 15 | 14 |
| Surface | Before | 10¹⁶< | 10²¹< | 10⁹~10¹² |
| resistivity | washing | | | |
| (Ω/□) | After | 10¹⁶< | 10¹⁴< | 10⁹~10¹² |
| | washing | | | |

As can be seen from the above Table 1, it was confirmed that the antistatic polyethylene film including the antistatic block copolymer according to the present disclosure (Example 1) can have similar cleanliness and excellent antistatic property, to that of the conventional PE film (control) for clean bags for semiconductors without deteriorating the physical properties thereof. On the other hand, it is understood that the polyethylene film containing the conventional surfactant (Comparative Example 1) has a large inhibition in the physical properties of the film (pure polyethylene film) made of base resin and poor cleanliness, with respect to the obtained antistatic property.

### Experimental Example 2

In the process of preparing the antistatic polyethylene film of Example 1 by the blown film forming process, the surface resistivity according to the expansion ratio (BLU) of the blown film was measured, and the surface state of the film was visually confirmed.

The addition ratio (%) of the antistatic block copolymer refers to the weight ratio of the sum of the conventional polyethylene and the additive antistatic agent to the additive antistatic agent, and BUR (expansion ratio) is calculated by the following Mathematical Formula 1.

BUR=(0.637×folded material width)/mold diameter [Mathematical Formula 1]

The test results are shown in Table 2.

TABLE 2

| | Surface resistivity (Ω/□) depending | | | | |
|---|---|---|---|---|---|
| | on addition ratio (%) of antistatic | | | | |
| | block copolymer | | | | |
| BUR | 5% | 10% | 20% | 30% | Remarks |
| 1.5 | 8 × 10¹¹ | 5 × 10¹¹ | 9 × 10¹⁰ | 2 × 10¹⁰ | Good film |
| | | | | | surface |
| 2.0 | 7 × 10¹¹ | 6 × 10¹⁰ | 8 × 10⁹ | 5 × 10⁹ | Good film |
| | | | | | surface |
| 2.5 | 5 × 10¹¹ | 4 × 10¹⁰ | 6 × 10⁹ | 4 × 10⁹ | Good film |
| | | | | | surface |
| 3.0 | 6 × 10¹¹ | 3 × 10¹⁰ | 5 × 10⁹ | 1 × 10⁹ | Melt fracture |
| | | | | | occurrence |

As can be seen from Table 2 above, it is confirmed that the surface resistivity is not impaired at the BUR 2.0 to 2.5 levels, but is better than the BUR 1.5 or lower level, and the film surface is also confirmed to be good.

### INDUSTRIAL AVAILABILITY

In the case where antistatic performance is required in the semiconductor industry, the pharmaceutical industry, the food industry, and so on which require a high level of cleanliness, the present invention can be used industrially.

Although a specific embodiment of a block copolymer antistatic agent for polyolefin including one or more hydrophilic blocks and one or more hydrophobic blocks, and an antistatic polyolefin film including the same according to the present disclosure has been described so far, it is apparent that various modifications can be made without departing from the scope of the present disclosure.

Therefore, the scope of the present disclosure should not be limited to the embodiments described, but should be determined by the equivalents of the claims, as well as the following claims.

That is, it is to be understood that the foregoing embodiments are illustrative and not restrictive in all respects and that the scope of the present disclosure is indicated by the appended claims rather than the foregoing description, and all changes or modifications derived from the equivalents thereof should be construed as being included within the scope of the present invention.

1. A block copolymer antistatic agent for a polyolefin film, configured to have the following structural features (a) to (d), and comprising a block copolymer comprising a hydrophilic block and a hydrophobic block:
(a) as a hydrophilic block which is important for antistatic property, a polyalkylene oxide block having a hydroxyl group at both terminals is used, and as a hydrophobic block which is important for compatibility and dispersibility with the polyolefin, a polyolefin block which is functionalized at both terminals is used,
(b) the hydrophilic block is prepared by adding alkylene oxide to amide alcohol and used in the form of an amide alcohol alkylene oxide, and the hydrophilic block and the hydrophobic block are connected through an ether bond or an ester bond,
(c) the hydrophilic block and the hydrophobic block is comprised in the antistatic agent in a weight ratio of 1:0.1-100, and
(d) a block copolymer comprising the hydrophilic block and the hydrophobic block has a weight-average molecular weight of 10 to 100 kDa.

2. The block copolymer antistatic agent of claim 1, wherein the hydrophilic polyalkylene oxide block and the hydrophobic polyolefin block are connected by an ester bond, and the ester bond is formed by a reaction of a polyolefin block functionalized by dicarboxylic acid or an anhydride thereof at both terminals with a polyalkylene oxide having hydroxyl at both terminals.

3. The block copolymer antistatic agent of claim 1, wherein the polyolefin film is a polyethylene film.

4. The block copolymer antistatic agent of claim 1, wherein the polyolefin block functionalized at both terminals is selected from a poly(ethylene-propylene) copolymer block functionalized at both terminals, and the terminals are functionalized by an α,β-unsaturated carboxylic acid or an anhydride thereof.

5. The block copolymer antistatic agent of claim 4, wherein a free carboxylic acid derived from an α,β-unsaturated carboxylic acid or an anhydride thereof at both terminals is protected or blocked with ester bonds, amide bonds or imide bonds by a pendant compound containing an alcohol group or amine group.

6. The block copolymer antistatic agent of claim 4, wherein the ethylene : propylene repeating unit ratio in the poly(ethylene-propylene) copolymer block in which both terminals are functionalized is 1:10-50, and the poly ethylene oxide block has a repeating unit of ethylene oxide ranging from 20 to 150.

7. A preparation method of an antistatic polyolefin film, comprising:
(1) preparing the block copolymer antistatic agent according to claim 1,
(2) mixing the block copolymer antistatic agent prepared in the above step (1) with a polyolefin as a base resin in an amount of from 0.01% by weight to 50% by weight
(3) melt-extruding the mixture obtained in the above step (2) into a film form by casting or blowing at a temperature of from 100° C. to 300° C.

8. An antistatic polyolefin film comprising the block copolymer antistatic agent according to claim 1.

9. An antistatic polyolefin film comprising the block copolymer antistatic agent produced by the preparation method of an antistatic polyolefin film according to claim 7.

10. The antistatic polyolefin film according to claim 8, wherein, an antistatic coefficient is 10⁹ to 10¹²Ω in a state maintaining a cleanliness of 1,000 or less particles per unit area, when measured by a liquid particle counter.
